(19) United States
(12) Patent Application Publication
(10) Pub. No.: US 2005/0050142 A1
(43) Pub. Date: Mar. 3, 2005

(54) Method and framework for transaction synchronization

(75) Inventors: Jeffrey Capone, Scottsdale, AZ (US); Pramod Immaneni, Tempe, AZ (US); Sudhakiran Venkata Mudiam, Chandler, AZ (US)

Correspondence Address: FOLEY & LARDNER, 2029 CENTURY PARK EAST, SUITE 3500, LOS ANGELES, CA, 90067, US

(73) Assignee: Aligo Inc.

(21) Appl. No.: 10/652,101

(22) Filed: Aug. 28, 2003

(51) Int. Cl. G06F 15/16

(52) U.S. Cl. 709/204

(57) ABSTRACT

A method and framework for transaction synchronization. An embodiment of the present invention first involves “cloning” the middle tier business logic layer from a server onto a client. The framework allows the cloned business logic on the client and the business logic layer on the server to operate independently without a connection. Therefore, the server-side and client-side applications can fully operate without a connection. When a connection is established, the framework synchronizes (reconciles according to defined rules) transactions (i.e., execution of functions) so that transactions resulting from the execution of a function on the business logic layer on the client is equivalent to a transaction resulting from a execution of a function on the business logic layer on the server. Embodiments of the invention may also be used in peer-to-peer environments.

### BACKGROUND

1. Field of the Invention

The present invention relates to data synchronization.

2. Description of Related Art

Mobile devices such as handheld or palmtop computers, cellular phones, personal digital assistants (“PDAs”) and the like are continually being improved in terms of their computing power and the size of their on-board memory. Such network-enabled devices are increasingly being used in peer-to-peer (P2P) environments and client-server environment using corporate and public network environments (e.g., the Internet) to access server-side applications. For example, mobile devices may be carried by corporate employees working in the field (e.g., salespersons calling on customers) and may communicate over a network with a corporate server running an enterprise application. These applications will need to be accessed by various mobile devices as “clients” to the server-side enterprise application. The employees may interact with these server-side applications while performing various functions on the client application.

A typical client application 100 is shown in FIG. 1. The application 100 includes, without limitation, a user interface (“UI”) 102, business logic 104 and a data repository 106. The UI 102 may allow information to be presented to a user in a user perceptible form, for example, by displaying the information on a display screen of the device. In addition, a user's gestures (e.g., a keyboard entry or pointer input) may be applied to the UI 102 and interpreted as actions. The business logic 104 receives the actions and may request stored application data from the repository 106 for use by the application 100.

The application 100 may be distributed. A distributed application typically includes both a client component and a server component of the application, whereas a local application resides on a single device. In a client-server application, depending on the capabilities of the client, it may be possible for parts of all three components of an application (i.e., the UI 102, the business logic 104 and the data repository 106) to exist on the client.

In the case of the World Wide Web (“WWW”), the client may be responsible for presentation only (UI 102). If the client includes a browser that supports JavaScript, for example, then a portion of the business logic 104 may exist on the client. If the browser supports Java, then the client can execute applets, and much more of the business logic 104 can exist on the client device.

Furthermore, depending on the memory capability in the mobile device, the information in the repository 106 may be shared between the mobile device and the server. Thus, information may be shared between the central server and the client application on the mobile device. In this manner, the mobile device may be used in an off-line mode, i.e., disconnected to the server.

When information is shared in this manner, there is a need to synchronize (or merge or reconcile) the shared information between the mobile device and the server. Synchronization refers to the reconciliation of changes among multiple instances of the information according to a set of rules dictating which instance takes precedence. For example, a simple rule may be that client information takes precedence over server information or vice versa, or that one peer device takes precedence over another peer device. Synchronization approaches have existed for many years and are used for database replication. Apart from data synchronization, data consistency on the client prior to the synchronization must be maintained (i.e., any local changes must be reflected throughout the application).

Today, distributed peer devices or clients with limited memory and occasional connectivity to a server, such as cellular phones and PDAs, are increasingly used to access multiple peer devices or multiple server-side applications. For such clients, new standards (such as, for example, SyncML) are evolving for describing data, representing changes to it, and indicating how to process it. These standards are only descriptions but do not dictate an overall framework or methodology for managing information and synchronization, and do not solve the complexities created by multiple applications and data stores.

There are several synchronization technologies available for synchronizing data between client applications running on mobile device and server-side applications. These technologies are broadly classified as application level synchronization and database level synchronization. In application synchronization, two or more applications share and reconcile data through the use of an intermediate application that translates the data from one application to a format for the other applications and visa versa. An example of application synchronization is the synchronization between calendar items on a Palmtop with a desktop calendar, each running a different calendar application. This synchronization is achieved through the use of intermediate application such as ActiveSync from Microsoft or Palm Desktop Software from Palm. In database synchronization, two or more applications share a common database schema and each application is built upon its own independent database. Each of the databases themselves employs database replication and synchronization technologies, such as Oracle 9i Lite, to achieve data synchronization among the various databases; therefore the data used by the distributed applications is synchronized. The synchronization operations in database synchronization can take too long over low-bandwidth wireless links and the alternative of lugging around cradles reduces the usability of the mobile device. Also database and application synchronization technologies do not give you the level of control of each transaction. For example, during a stock trade, a trader might want the latest trading price. Price values should be returned from the server and not from the local data source. However, non-time sensitive data should be retrieved from the local data store. In addition, these synchronization solutions have not been designed for operation over intermittent, high-latency wireless links. Furthermore, existing synchronization systems generally transfer entire database files or records between one mobile device and another peer device or server and compare the files on the server-side. This requires long connection and processing times and increased costs and the alternative of lugging around cradles reduces the usability of the client application.

In embodiments of the present invention, a new class of synchronization is developed that synchronizes transactions. A transaction is defined as the function, the parameters used by the function and the data returned by the processing of the function. This new class of synchronization may conceptually be viewed as a layer above database synchronization.

### SUMMARY

An embodiment of the present invention provides a method and framework for synchronizing information (transactions) between clients and servers having layered application architectures. However, the same method and framework would apply to synchronizing data between peer devices in a peer-to-peer environment. For clarity, the method and framework will be described in, but is not limited to, a client-server environment. An embodiment of the invention first involves “cloning” the middle tier business logic layer from the server onto the client. The “cloning” process requires that the functions available in the business logic layer and the data returned by those functions be converted to a format supported on the client (mobile device). The framework allows the cloned business logic on the client and the business logic layer on the server to operate independently without a connection. Therefore, the server-side and client-side applications can fully operate without a connection. When a connection is established, the framework synchronizes (reconciles according to defined rules) transactions (i.e., execution of functions) so that transactions resulting from the execution of a function on the business logic layer on the client is equivalent to a transaction resulting from a execution of a function on the business logic layer on the server. The framework may also allow for the cloned business logic layer on the client to be consistent in the data returned from it even before synchronization.

An embodiment of the present invention provides a framework for synchronizing client and servers over occasionally connected, high-latency wireless links using network connections, such as, for example, standard Internet connections (TCP/IP, HTTP) and other connection protocols. The framework allows for each transaction (i.e., execution of a function on the client business logic) to be queued, and independently and reliably transported to the server. Since the transactions on the client can occur independently of the server, when synchronizing with the server there can be conflicts with transactions from other clients. The framework allows for resolution of such conflicts.

An embodiment of the present invention provides a framework to synchronize transactions created in the client and server business logic layers. The framework also provides for controlling the execution flow (path) of the synchronization process of the function on the client. For example, flow may be determined based on whether the transaction should be created from a transaction that has been stored on the client or whether the transaction on the client should never be out of synchronization with the corresponding transaction on the server.

### BRIEF DESCRIPTION OF THE DRAWINGS

The accompanying drawings, which are incorporated in and constitute a part of the specification, illustrate embodiments of the invention, and together with the general description given above and the detailed description of the embodiments given below, serve to explain the principles of the invention.

FIG. 1 shows a typical end-user application in a mobile environment according to the prior art.

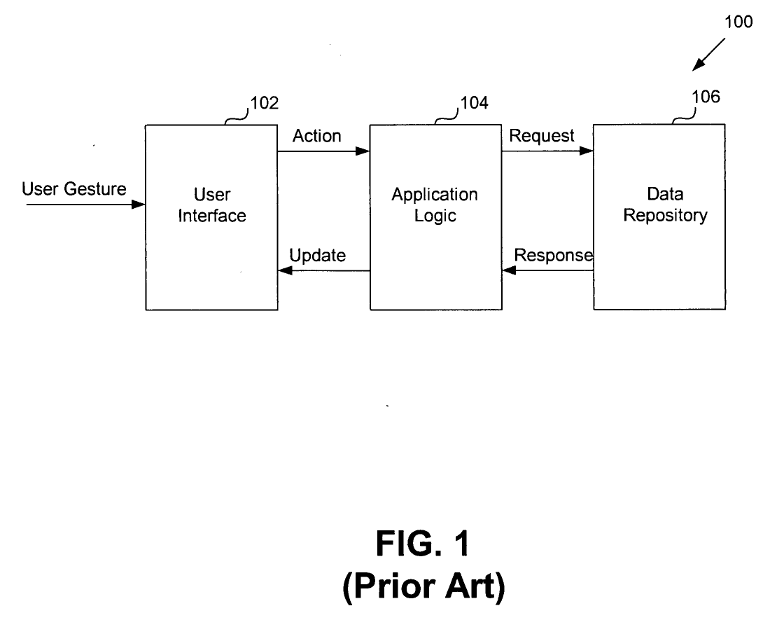

FIG. 2 shows an environment in which embodiments of the present invention may be implemented according to embodiments of the present invention.

FIG. 3 shows an environment in which embodiments of the present invention may be implemented according to embodiments of the present invention.

FIG. 4 shows Java Platform 2, Enterprise Edition application model according to the prior art.

FIG. 5 shows a block diagram of a synchronization architecture according to embodiments of the present invention.

FIG. 6 shows a method for synchronizing data according to an embodiment of the present invention.

FIG. 7 shows block diagrams of a client mobile device and a system server according to an embodiment of the present invention.

### DETAILED DESCRIPTION

In the following description of preferred embodiments, references are made to the accompanying drawings which form a part hereof and in which are shown, by way of illustration, specific embodiments in which the invention may be practiced. It is to be understood that other embodiments may be utilized and structural changes may be made without departing from the scope of the preferred embodiments of the present invention.

Although the following description is directed primarily toward data synchronization in software environments having layered or tiered architectures, such as, for example, the Java 2 Platform, Enterprise Edition (J2EE), embodiments of the present invention may be used in a variety of environments, applications and architectures. Generally, embodiments of the present invention may be used in any environment, application or architecture in which data synchronization is required.

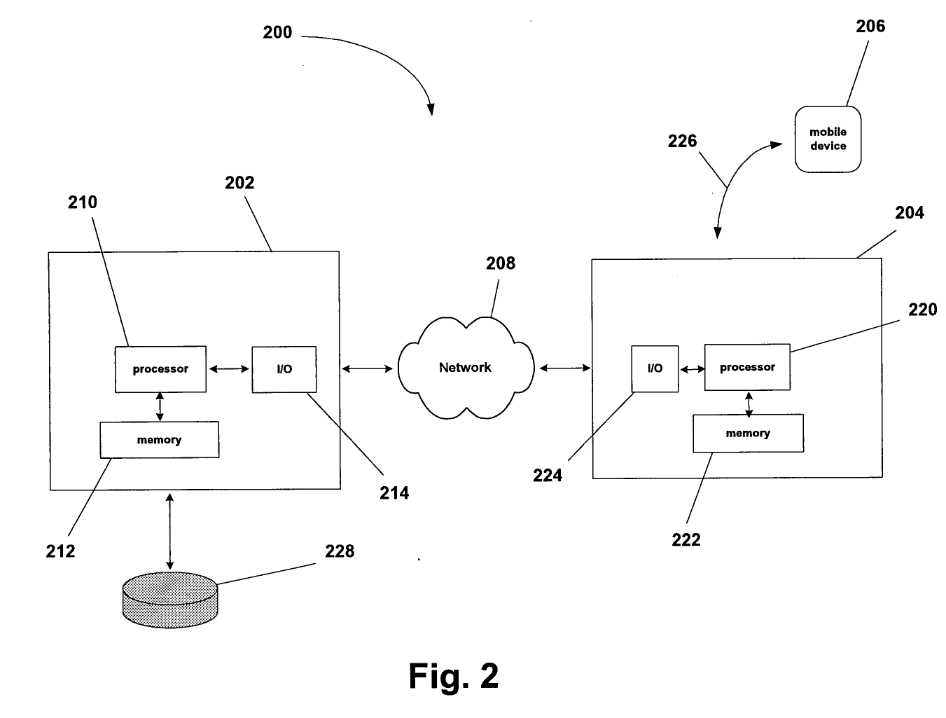

A hardware environment in which embodiments of the present invention may be implemented is shown in FIG. 2. The environment 200 shown in FIG. 2 is a P2P environment and includes, but is not limited to, a first peer device 202, a second peer device 204 and a third peer device 206. The first peer device 202 may be a server computer, for example, while the second peer device 204 may be a desktop or a laptop computer, for example. The third peer device 206 may be a mobile device such as, for example, a cellular telephone, a personal digital assistant, other wireless devices and the like.

The first peer device 202 may include, but is not limited to, a processor 210, memory 212 and I/O 214. The first peer device 202 may communicate directly with a database 228. The database 228 may be implemented in a variety of ways as is common in the art.

The first peer device 202 may communicate with the second peer device 204 via a network 208. The network 208 may be a wireless or wired network and may be implemented using a variety of technologies as known in the art. For example, the network 208 may be a local area network, a wide area network, the Internet, an intranet or the like.

The second peer device 204 may include, but is not limited to, a processor 220, memory 222 and an I/O unit 224. The second peer device 204 may communicate with the third peer device 206 over a wireless connection 226. The wireless connection 226 may be an RF connection, an infrared connection, an optical connection or the like.

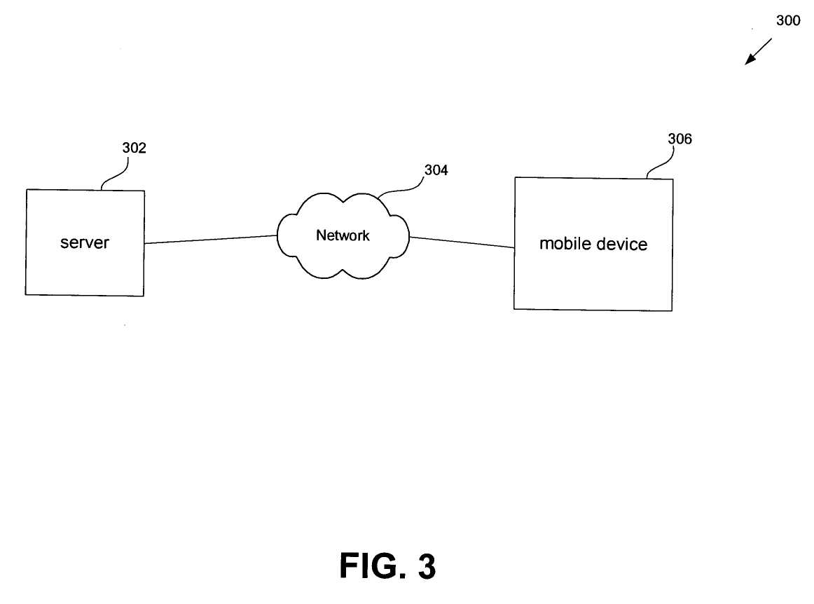

FIG. 3 shows another environment 300 in which embodiments of the invention may be implemented. The environment 300 shown in FIG. 3 is a “client-server” environment in which a client 306 communicates with a server 302 via a network 304. The client 306 may be a variety of computing devices such as, for example, a desktop computer, a laptop computer, a handheld device or the like. The network 304 may be any of a variety of networks such as, for example, a local area network, a wide area network, the Internet, an intranet or the like. The network 304 may be a wireless network or may be a wired network. The server 302 may be a standard computer server as is well known in the art.

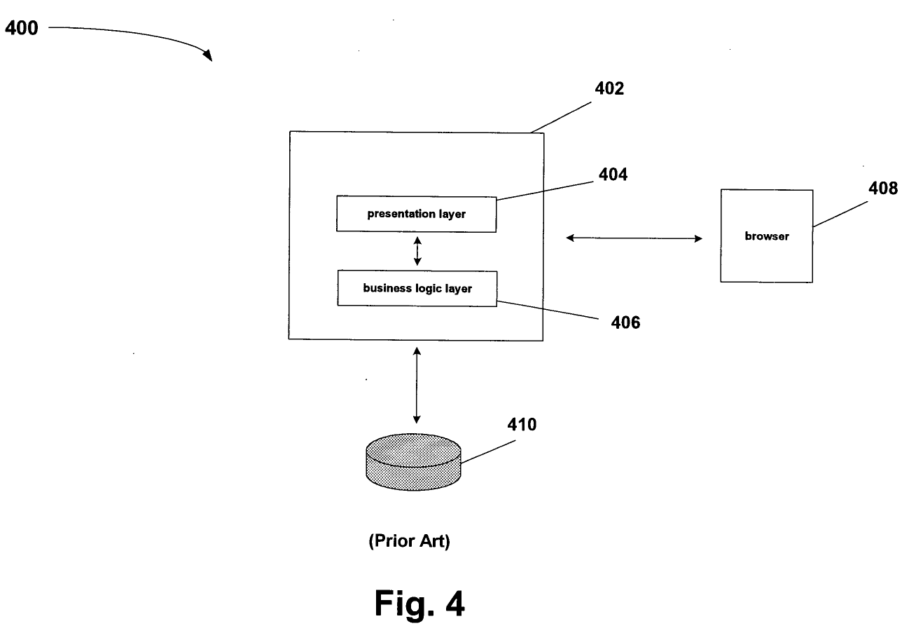

Many applications are currently designed using a layered architecture. For example, many applications designed for the J2EE, use the application model 400 shown in FIG. 4. The J2EE application model 400 shown in FIG. 4 includes, but is not limited to, a J2EE server 402, a presentation layer 404, a business logic layer 406, and a data source (for example, but not limited to, a database) 410. In addition, the presentation layer 404, business logic layer 406, and data source 410 may exist within a J2EE application 400. The J2EE server 402 may communicate with a web browser 408. Communication may take place over a variety of networks and may be implemented using http.

The presentation layer 404 of the J2EE application model 400 may be implemented using HTML or Java server pages (JSP), for example. The business logic layer 406 may include a data access layer (not shown) for communication with a data source 410. For the purposes of discussion, embodiments of the present invention will be described in connection with the J2EE application model 400. However, embodiments of the present invention may be implemented in a variety of architectures for a variety of applications and are not limited to architectures or applications based on the J2EE application model 400 shown in FIG. 4.

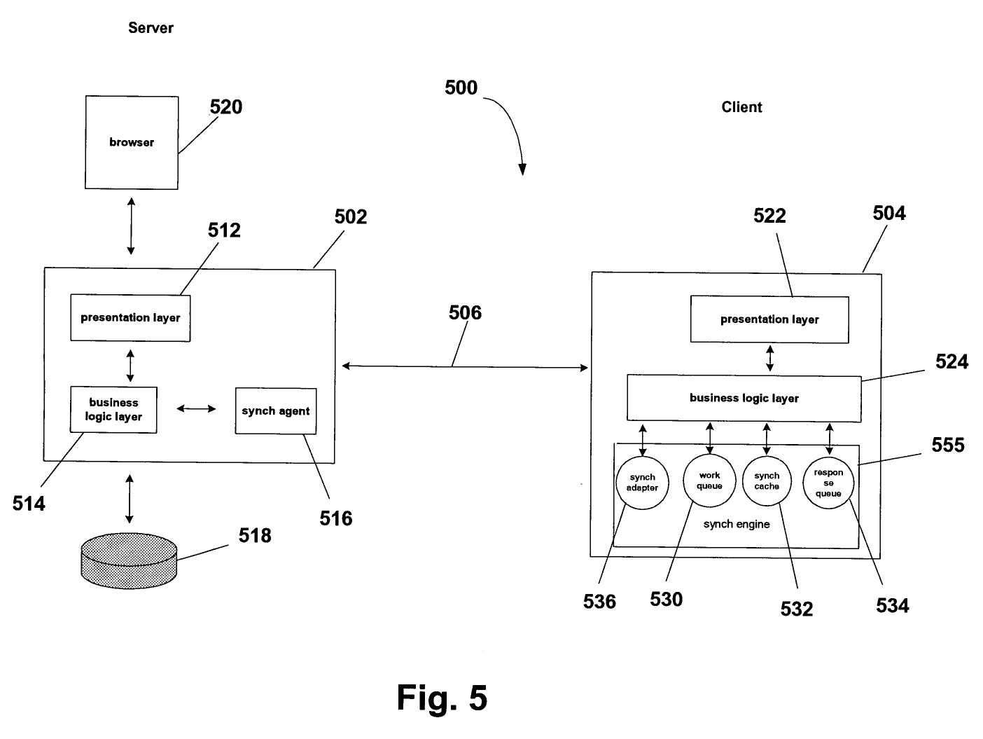

FIG. 5 shows a block diagram of an application architecture according to embodiments of the present invention. The block diagram shown in FIG. 5 is based on the J2EE application model. However, embodiments of the invention may be based on other application models and are not limited to the J2EE application model. In FIG. 5, the architecture 500 includes a server 502 and a client device 504. The server 502 may be any device, for example, while the client 504 may be a mobile device, such as, for example, the mobile device shown in the environment in FIG. 3. The server 502 and the client 504 may communicate over a communication link 506 using a variety of transport protocols such as HTTP, SOAP, SyncML, and the like.

In the embodiment of the invention shown in FIG. 5, the server 502 may include a variety of software layers. For example, the server 502 may include a presentation layer 512 and a business logic layer 514. In addition, the business logic layer may interface with a synch agent 516 that is responsible for processing transactions on the server and processing the reconciliation rules when synchronizing the transactions between the client and server business logic layers. The business logic layer may also interface with a data sources 518. The presentation layer 512 may interface with a web browser 520 or some other mechanism for information display.

The client application 504 may also include a plurality of software layers. For example, the client application 504 may include a presentation layer (i.e., user interface) 522, a [mobile] business logic layer 524, and a synch engine 555. In addition, the business logic layer 524 may interface with the synch engine 555 for performing transactions.

In the embodiment of the invention shown in FIG. 5, the business logic layer 524 of the client 504 “mirrors” the business logic 1 layer 514 of the server 502. In other words, the business logic layer 524 of the client 504 is a twin of business logic layer 514 of the server 502. Thus, the business logic layer 524 of the client device 504 may include the same function names, the same method signatures (i.e., the same function calls) and act like the business logic layer 514 of the server 502. Accordingly, according to embodiments of the present invention, synchronization of transactions that have changed at the client 504 with respect to original transactions that exists on the server 502 may occur at the sync agent 516 as will be explained in greater detail below.

The synch engine 555 may include a variety of components for managing transactions that facilitate transaction synchronization. For example, the synch engine 555 may include a work queue 530, a synch cache 532, a sync adaptor 536 and a response queue 534. However, the synch engine 555 is not limited to the work queue 530, the synch cache 532 and the response queue 534 and may include a variety of other components as well.

In the client application 504, the business logic layer 524 and the synch engine 555 work in conjunction to keep track of any transactions performed on the client 504. For example, an original transaction downloaded from the server 502 to the client 504 through the connection 506 may be stored in the synch cache 532 to support a new transaction on the client, such as, for example, inserts, updates and deletes. Also, a record of all inserts, updates and deletes or other transactions performed are maintained in the work queue.

The synch engine 555 may be used for a variety of functions. For example, when a connection 506 is established between the server 502 and the client 504, the synch engine 555 in conjunction with the synch agent 526 may communicate with the synch agent 516 of the server 502 when synchronization is invoked by the application.

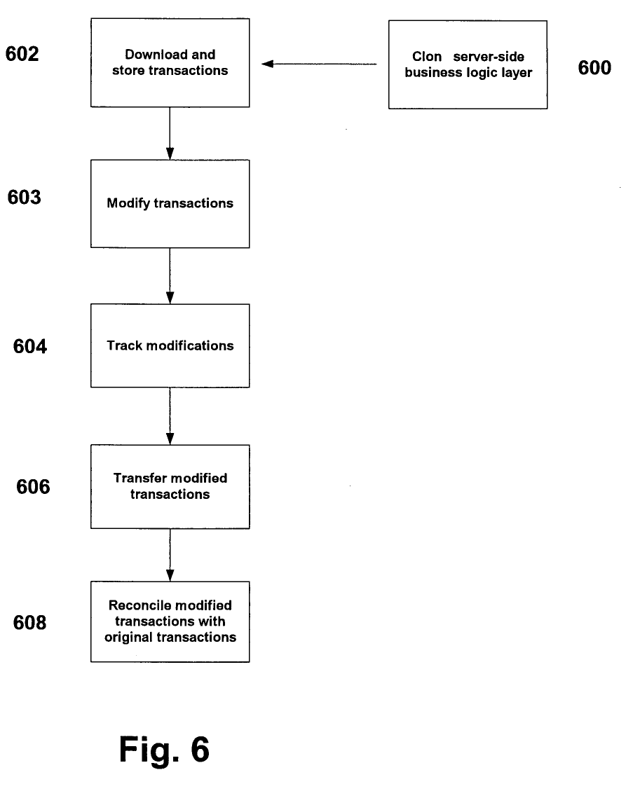

FIG. 6 shows a process for synchronizing transactions according to an embodiment of the present invention. Referring to FIGS. 5 and 6, at step 600 the business logic layer 524 of the server is cloned in a format suitable for the client and deployed onto the client. After functions in the server business logic layer 514 are identified for the synchronous application, the client business logic layer 524 may be generated for client mobile device 504 that replicates the functions on the server business logic layer 514. Because these functions are twins of functions in the server business logic layer 514 and have the same functionality, the functions replicated on the client business logic layer 524 may operate on data sets in the same manner as the functions in the server business logic layer 514 which they replicate.

At step 602, transactions (execution of functions) may be downloaded from the server 502 to the client 504 by executing a function (i.e., creating a transaction) on the client business logic layer 524. The client 504 executes the function which causes the synch engine 555 on the client to request the synch agent on server 502 to create the transaction (i.e., execute the function) at the server 502 and transport it to the sync engine 555 on the client that stores the newly created transaction in the synch cache.

For example, if the client 504 executes a function such as getJobsByTechId (tech Id), the synch agent at the server 502 would return the transaction which contained the function, its parameters and an array of beans of type Job, to the client 504. The resulting transaction may be used to support other functions in the business logic layer 524 of the client 504 that may be used to create additional transactions locally by executing, updates, inserts, deletes while being disconnected from the server application 502. Transactions that are stored in the synch cache 532 of the client 504 may be uniquely identified. Moreover, there may be a relationship between two or more transactions. For example, the transaction that results from getJobsByTechId may be related to the transaction resulting from getJobsByTechIdByJobId. Thus, a relationship between a function, its parameters and a resulting dataset may be preserved so that additional functions in the business logic layer 524 of the client 504 may be supported. Accordingly, the transaction (function name, the parameters and resulting data) and a session ID may be wrapped into an object referred to as MethodInfo, for example and stored in the synch cache 532. The synch cache 532 may be implemented in a manner in which a MethodInfo can be quickly accessed.

At step 603, new transactions are created by executing functions in the business logic layer 524 on the client 524. According to embodiments of the present invention, new transactions may be created at the client 504 from former transactions located in the synch cache. For example, if the client 504 is a mobile device, the mobile device may be disconnected from the server 502 but may be performing transactions on a transaction that has been downloaded from the server 502 to the mobile device. More specifically, for example, a transaction created from the execution of getJobsByTechId may be stored in the synch cache on the client 504. From this transaction stored on the client 504, a new transaction may be created on the client 504 my executing functions such as getJobByTechIdByJobId or updateJob on the client business logic layer. Transactions created on the client 504 such as updateJob, insertJob or deleteJob, for example, will modify the transactions stored in the synch cache, since the transactions are being created from the transactions downloaded to the mobile device. When the mobile device reestablishes a connection with the server 502, the transactions existing on the mobile device may be different than the transactions that were originally downloaded to the mobile device from the server 502 and, accordingly, may require synchronization with the server 502.

At step 604, all modifications performed on the transactions in step 602 may be recorded. Step 604 may be performed in conjunction with step 602. For example, all inserts, updates and deletes to transactions stored in the synch cache 532 may be recorded. These transactions, as well as other transactions that may be implemented in the data access layer 525 of the client 504, correspond to functions called on the business logic layer 524 of the client 504. Therefore, referring to the previous example, these transactions may be represented by a MethodInfo. In addition, according to embodiments of the present invention, the order of the transactions may be important, and, thus, may be stored in a queue such as the work queue 530, for example.

At step 606, modified transactions are transferred from the client 504 to the server 502 using the connection 506. According to an embodiment of the present invention, modified transactions at the client 504 may be transported to the server 502 using http or other transmission protocol. A variety of methods may be used to perform the transfer. For example, transporting data may include a “get” method that may correspond to a one-way synch from the first peer device 502; an “update” method, which may correspond to a one-way synch from the second peer device 504; or an “update-get” function, which may correspond to a two-way synch operation. The “get” function may pass a methodInfo with an empty result set and return a MethodInfo with a result set. The “update” function may pass a MethodInfo containing a result set and may return a status response. The “update-get” function may pass a MethodInfo containing a result set and return a MethodInfo with an updated result set.

According to an embodiment of the present invention, before the MethodInfos in the work queue 530 may be transported, they may require serialization. A variety of methods may be used to serialize the MethodInfos o in the work queue 530. For example, the MethodInfos may be serialized using a SyncML representation. In addition, a SyncML representation may also be used to serialize the contents of the synch cache for data read into the local file system. The MethodInfos may be represented in the form of a SyncML message that describes the data, changes to the data and how to process the data so that any SyncML application may read and process the data.

In order to effectively transfer the modified data from the client 504 to the server 502, a component may be implemented in the client 504 that manages the execution flow or path for the transaction. For example, this component may be a module referred to as the “execution object” and may interface with all other modules. According to an embodiment of the present invention, the execution object may control whether to access the synch cache 532, defer a transaction to the work queue 530 or try to connect with the server 502. In addition, the execution object may call a transport module and wait for a response from the first peer device 502, then clear the work queue 530 and then update the synch cache 532.

At step 608, the modified transactions on the client 504 are reconciled with the server-side 502 transactions, which are effected by executing the corresponding function at the server business logic layer with the same parameters contained in the methodInfo sent from the client 504. According to embodiments of the present invention, for every function that exists in the business logic layer 524 of the client 504, there may be a corresponding synch agent object on the server 502 that may be responsible for processing and reconciling the MethodInfo sent by the client 504. According to embodiments of the present invention, in order to process and reconcile the MethodInfo (transactions) in the most flexible manner, the synch agent should have access to the transactions that were most recently checked out by the client 504. The transaction that was most recently checked out by the client 504 may be stored in a synch cache implemented on the server 502. Thus, according to embodiments of the present invention, the synch agent may have access to transactions that currently are on the client 504, transactions that were previously checked out by the client 504, and transactions that are currently on the server 502. All three of these transactions sets may be used to reconcile changes according to user defined business rules.

According to embodiments of the present invention, the server 502 may also include a servlet that receives a request from the second peer device 504; de-serializes the MethodInfo; identifies a corresponding synch agent and passes it the MethodInfo; and sends the updated MethodInfo back to the client 504. The servlet may receive the request using http or other transmission protocol. Additionally, the servlet may serialize the updated MethodInfo and send it back to the client 504. The corresponding synch agent may be identified in the MethodInfo itself or in the URL if an execution object sets it.

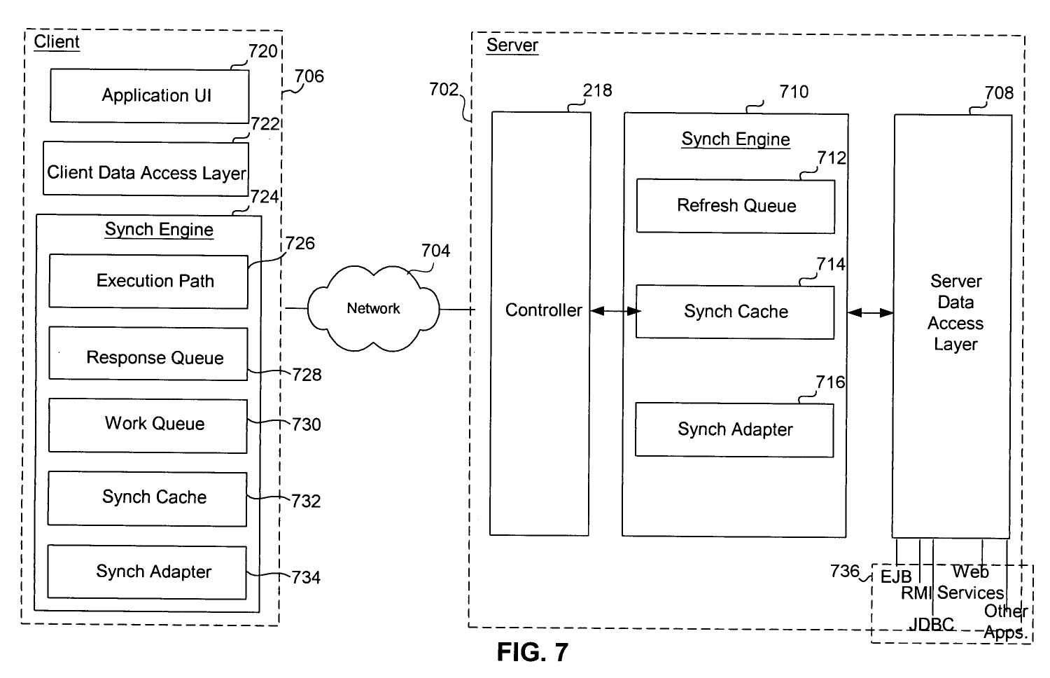

FIG. 7 shows detailed block diagrams of a client mobile device 706 and a system server 702 according to embodiments of the present invention. The system server 702 includes, but is not limited to, a server business logic layer 708, a server synchronization agent 710 (including, without limitation, a refresh queue 712, a synch cache 714 and a synch adapter 716) and a controller 718. The client mobile device 706 includes, without limitation, an application UI 720, a client business logic layer 722, and a synch engine 724 (including an execution path 726, a response queue 728, a work queue 730, a synch cache 732 and a synch adapter 734.

According to a an embodiment of the present invention, the system server 702 may be, but is not limted to, any J2EE-compliant or compatible application server including, but not limited to, IBM WEBSHPERE, BEA WEBLOGIC, ORACLE 91 and Sun ONE SERVERS. The client mobile device 706 may be, but not limited to, any Java enabled mobile device such as, but not limited to, Java cell phones, laptops, BLACKBERRYs, PALM OS and POCKET PCs. According to embodiments of the present invention, the client mobile device 706 may run applications based on open industry standards such as J2ME, pJava, J2SE, NET and NET Compact Framework. Java resources 736 such as, but not limited to, EJB, RMI, JDBC, Web Services, applications such as Seibel, and the like may be accessible to the client mobile device 706 through the server data access layer 708. The server business logic layer 708 may translate messages from the application UI 720 of the client mobile device 706 into proper queries for the resources 736.

The client mobile device 706 may communicate with the system server 702 by establishing a connection over the network 704 in a known manner and may access the resources 736 through the server business logic layer 708. While the system server 702 and the client mobile device 706 are connected, the synch agent 710 distributes synchronizes transaction between the server business logic 708 to the client mobile device 706 under the control of the controller 718. The controller 718 may be, for example, one or more processors, software, firmware, hardware comprising hardwired logic, or any combination thereof.

As discussed above, while the system server 702 and the client mobile device 706 may be connected, particular transaction sets may be identified to be made available to particular client devices. According to embodiments of the present invention, the particular transactions may be created by identifying particular functions to execute on the server business logic layer 708 to be converted (in a format suitable for the client) and transported to the mobile device 706.

As discussed above, during run-time the synch engine 724 may automatically check out and create transactions by communicating with the sync agent 710 that may be required to support functions on the client business logic layer 722. The functions replicated on the client business logic layer 722 may operate on data in the same manner as the functions in the server business logic layer 708 which they replicate. In this manner, with the client business logic layer 722, the application UI 720 may create transactions, for example, inserts, updates and deletes, without having a connection to the server.

The replication of server-side transactions on the client device may be performed during run time. The synchronization engine may automatically check out and replicate transactions from the server that is required to support functions made available on the client device. For example, a transaction pertinent to a particular sales person may be checked out and replicated on the client device by executing the function getSalesOpportunitiesBySalesPerson on the client business logic layer. The client device may then operate offline, for example, by making insertions, deletions and updates to this transaction. When a connection is available to the server, the alterations to this transaction may be synchronized with the server-side.

When a connection between the server and client device is again available, transactions on the client mobile device 706 may be synchronized with transaction on the system server 702. According to embodiments of the present invention, standards for describing and transporting the transactions (i.e., MethodInfos) between the client and server include, but are not limited to, for example, eXtended Markup Language (XML), Simple Object Access Protocol (SOAP) or SyncML. At the server, the transaction may be updated based on predefined business rules.

While particular embodiments of the present invention have been shown and described, it will be obvious to those skilled in the art that the invention is not limited to the particular embodiments shown and described and that changes and modifications may be made without departing from the spirit and scope of the appended claims.

1. A method for synchronizing a transaction between devices having layered application architectures comprising:
copying a business logic layer of an application on a first device to an application on a second device;
receiving, at the second device, a first transaction from the first device;
modifying, in a business logic layer of the application on the second device, the first transaction received from the first device; and
sending, from the second device to the first device, a second transaction,
wherein the business logic layer of the application on the first device reconciles the modified transaction with the original transaction, and
wherein the first transaction has been modified by the business logic layer of an application on the second device to become the second transaction.

2. The method of claim 1, wherein the business logic layer of the application on the second device mirrors the business logic layer of the application on the first device.

3. The method of claim 1, wherein the second device is a mobile device.

4. The method of claim 1, wherein the first device is a laptop computer.

5. The method of claim 1, wherein the first device is a server.

6. The method of claim 1, wherein the second device is a client.

7. The method of claim 1, wherein in the step of sending, the transaction is sent over a network.

8. The method of claim 7, wherein the network is the Internet.

9. The method of claim 1, wherein in the step of sending, the transaction is sent via a wireless connection.

10. The method of claim 1, wherein in the step of modifying, the transaction is modified while the second device is disconnected from the first device.

11. The method of claim 10, wherein the modified transaction is reconciled with the original transaction when the second device reconnects with the first device.

12. The method of claim 1, further comprising tracking modifications made to the transaction.

13. A method for synchronizing transactions between devices having layered application architectures comprising:
transferring a business logic layer of an application on a first device to an application on a second device;
receiving, at the first device, a request for a first transaction;
transferring, from the first device to a second device, the first transaction; and
receiving, at the first device and after transferring the first transaction, a second transaction from the second device,
wherein the business logic layer of the application on the first device reconciles the second transaction with the first transaction.

14. The method of claim 13, wherein the first transaction has been modified at a business logic layer of an application on the second device to become the second transaction.

15. The method of claim 13, wherein the business logic layer of the application on the second device mirrors the business logic layer of the application on the first device.

16. The method of claim 13, wherein the first transaction and the second transaction are received via a wireless connection.

17. The method of claim 13, wherein the first transaction and the second transaction are received over a network.

18. The method of claim 17, wherein the network is the Internet.

19. A system for synchronizing transactions between devices having layered application architectures comprising:
a first device having a processor for processing a first transaction;
memory for storing the first transaction, the memory having a connection to the processor;
an output unit connected to the processor, the output unit adapted to query a second device for the first transaction;
an input unit connected to the processor, the input unit adapted to receive the first transaction; and
a modification unit connected to the processor, the modification unit adapted to modify the transaction, whereby the first transaction becomes a second transaction,
wherein the second transaction is sent from the first device to the second device.

20. The system of claim 19, wherein a business logic layer at the second device reconciles the second transaction with the first transaction.

21. The system of claim 19, wherein the input unit receives the first transaction via a wireless connection.

22. The system of claim 19, wherein the input unit receives the first transaction over a network.

23. The system of claim 22, wherein the network is the Internet.

24. The system of claim 19, wherein the first device is a mobile device.

25. A system for synchronizing data between peer devices having layered application architectures comprising:
means for copying a business logic layer of an application on a first device to an application on a second device;
means for receiving, at the second device, an original transaction from the first device;
means for modifying, in the business logic layer of the application on the second device, the original transaction received from the first device; and
means for sending, from the second device to the first device, the modified transaction,
wherein the business logic layer of the application on the first device reconciles the modified transaction with the original transaction.

26. The system of claim 25, wherein the second device is a mobile device.
